(19) United States
(12) Patent Application Publication
(10) Pub. No.: US 2016/0107645 A1
(43) Pub. Date: Apr. 21, 2016

(54) DEPARTURE PREVENTION SUPPORT APPARATUS

(71) Applicants: TOYOTA JIDOSHA KABUSHIKI KAISHA, Toyota-shi, Aichi (JP); DENSO CORPORATION, Kariya-shi, Aichi (JP)

(72) Inventors: Yuji OKUDA, Toyota-shi (JP); Yoichi IWATA, Nagoya-shi (JP); Takahito NAKANO, Kariya-shi (JP); Takashi KAWAI, Kariya-shi (JP); Junpei TATSUKAWA, Chiryu-shi (JP); Tetsuya TAKAFUJI, Anjo-shi (JP)

(73) Assignees: DENSO CORPORATION, Kariya-shi, Aichi (JP); TOYOTA JIDOSHA KABUSHIKI KAISHA, Toyota-shi, Aichi (JP)

(21) Appl. No.: 14/788,000

(22) PCT Filed: Jun. 5, 2014
(86) PCT No.: PCT/JP2014/065526

§ 371 Date: Oct. 29, 2015

(30) Foreign Application Priority Data
Jun. 19, 2013 (JP) 2013-128897

(51) Int. Cl. B60W 30/12; B60W 10/18; G06K 9/00; B60W 10/20

(52) U.S. Cl. CPC B60W 30/12; B60W 10/20; B60W 10/18; G06K 9/00798; B60W 2420/42; B60W 2550/00; B60W 2710/18; B60W 2710/20

(57) ABSTRACT

A departure prevention support apparatus includes a lane boundary sign recognizing part configured to recognize a lane boundary sign; a departure detecting part configured to detect a departure of the host vehicle from the lane boundary sign; and a target travel line generating part configured to generate a target travel line if the departure detecting part detects the departure, wherein the target travel line includes a first target travel line for reducing the departure, and a second target travel line for modifying a direction of the host vehicle whose departure has been reduced after having traveled along the first target travel line; wherein the target travel line generating part sets one of the first target travel line and the second target travel line such that it is substantially straight, depending on a direction of the departure and a direction of a curvature of the lane boundary sign.

### TECHNICAL FIELD

The present invention is related to a departure prevention support apparatus for preventing a host vehicle from departing from a traveling lane of the host vehicle.

### BACKGROUND ART

A departure prevention support apparatus for preventing a host vehicle from departing from a traveling lane of the host vehicle is known. The departure prevention support apparatus applies a steering torque in a direction opposite to a direction of a departure or applies a braking force to wheels to generate yaw moment when the departure tendency is detected, in order to prevent the host vehicle from departing from the traveling lane.

An example of a situation where the departure prevention support apparatus is easily operated is when the vehicle travels along a curve. Therefore, a technique for preventing the departure from the traveling lane during the traveling along the curve is proposed (see Patent Document 1, for example). According to a lane departure prevention support apparatus disclosed in Patent Document 1, when the tendency of the departure in an inward direction of the curve, the generation of the yaw moment is limited. This control is performed so as to prevent a driver who tends to travel the vehicle along an inward side of the curve from having a strange feeling or prevent the host vehicle from directing to an outward direction of the curve.

[Patent Document 1] Japanese Laid-open Patent Publication No. 2005-145243

### DISCLOSURE OF INVENTION

### Problem to be Solved by Invention

However, there is a problem that just limiting the generation of the yaw rate or preventing the departure in a direction opposite to a direction of the departure, as performed in the departure prevention support apparatus disclosed in Patent Document 1, cannot prevent the departure at an exit of the curve.

FIG. 1 is an example of a diagram for explaining departure prevention at the exit of the curve. During the traveling of the vehicle, a curvature of a lane is calculated in recognizing the lane around the vehicle including the lane in front of the vehicle. Because the calculated curvature has a relatively great variation, the departure prevention support apparatus uses the curvature for control which has passed through a low-pass filter. Thus, the curvature that the departure prevention support apparatus uses for the control is its past value. There is no substantial problem when the curvature does not change substantially; however, there may be a situation in the course of the change of the curvature in which the curvature used for the control is different from that of the road on which the vehicle is traveling.

Thus, if the departure tendency is detected at the exit of the curve, the departure prevention support apparatus determines a shape of the road based on the past curvature of the curve even if the curve is about to end, and thus performs the control for the departure prevention based on a constant curvature that is detected when the departure tendency is detected. As a result of this, the following problems occur.

In FIG. 1, dotted lines represent a shape of the road with a constant curvature when the departure tendency in an outward direction of the curve is detected. The curvature is greater than an actual road shape (solid lines). The departure prevention support apparatus performs the departure prevention control directing to a center direction of the traveling lane, as indicated by an arrow, if the departure tendency is detected. However, because a target trace line is generated based on a constant curvature detected when the departure tendency is detected, a departure may be induced in a direction opposite to the detected departure direction.

Further, when the departure tendency in an inward direction of the curve is detected, the departure may be induced. In the example illustrated in FIG. 2, the departure tendency in an inward direction of the curve is detected, and the vehicle is controlled toward the center direction of the traveling lane to prevent the departure. However, because the departure prevention support apparatus generates a target line based on the constant curvature of the road that is detected when a departure tendency is detected, a departure may be induced in the same direction as the detected departure direction

In this way, there are problems that when the departure tendency in the outward direction of the curve is detected at the exit of the curve, the departure in a direction opposite to the detected departure direction may occur, and when the departure tendency in the inward direction of the curve is detected at the exit of the curve, the departure in the detected departure direction may occur.

The present invention is made in consideration of the problems described above, and an object of the invention is to provide a departure prevention support apparatus that can appropriately prevent departure at an exit of a curve.

### Means to Solve the Problem

The present invention is characterized in that it includes a lane boundary sign recognizing part configured to analyze a captured image of a scene around a host vehicle to recognize a lane boundary sign; a departure detecting part configured to detect a departure of the host vehicle from the lane boundary sign; and a target travel line generating part configured to generate a target travel line if the departure detecting part detects the departure, wherein the target travel line includes a first target travel line for reducing the departure, and a second target travel line for modifying a direction of the host vehicle whose departure has been reduced after having traveled along the first target travel line; wherein the target travel line generating part sets one of the first target travel line and the second target travel line such that it is substantially straight, depending on a direction of the departure detected by the departure detecting part and a direction of a curvature of the lane boundary sign.

### Advantage of the Invention

It is possible to provide a departure prevention support apparatus that can appropriately prevent departure at an exit of a curve.

### BRIEF DESCRIPTION OF DRAWINGS

FIG. 1 is an example of a diagram for explaining departure prevention at an exit of a curve.

FIG. 2 is an example of a diagram for explaining departure prevention at an exit of a curve when a departure tendency in an inward direction of the curve is detected.

FIG. 3 is an example of a diagram for explaining departure prevention at an exit of a curve by a lane departure prevention support apparatus.

FIG. 4 is an example of a diagram for schematically illustrating a configuration of a lane departure prevention support apparatus.

FIG. 5 is an example of a functional block diagram of a controlling part.

FIG. 6 is an example of a diagram for explaining a calculation of road information by a white line recognition apparatus.

FIG. 7 is an example of a diagram for explaining a first line and a second line in the case of an outward departure.

FIG. 8 is an example of a diagram for explaining a first line and a second line in the case of an inward departure.

FIG. 9 is an example of a diagram for explaining a target trace line in the case of an outward departure.

FIG. 10 is an example of a diagram for explaining a target trace line in the case of an inward departure.

FIG. 11 is an example of a flowchart for illustrating an operation procedure of the lane departure prevention support apparatus.

FIG. 12 is an example of a functional block diagram of a controlling part.

FIG. 13 is an example of a diagram for illustrating target steering torques of the first and second lines at the time of the outward and inward departure.

FIG. 14 is a diagram for schematically illustrating the second line that has made substantially straight at the time of the outward departure.

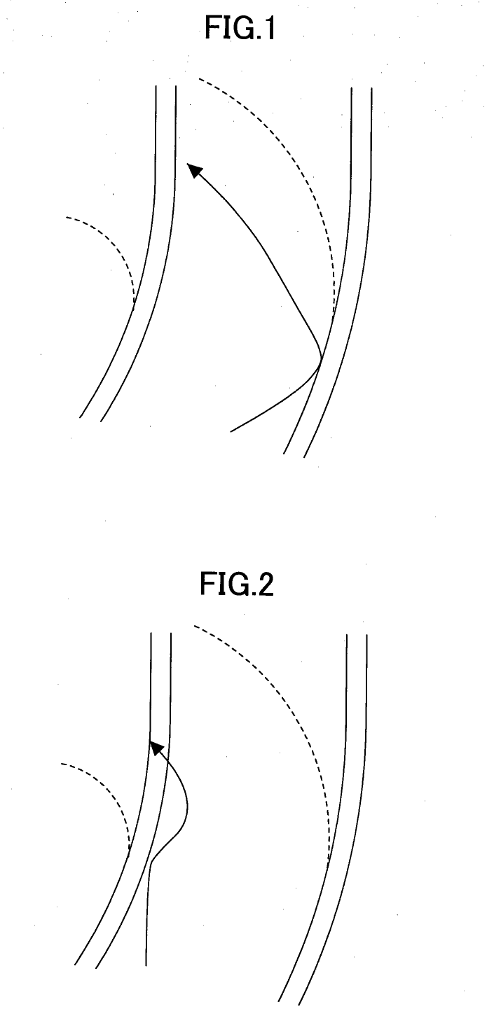

### DESCRIPTION OF REFERENCE SYMBOLS

11 forward camera
12 white line recognition device
15 controlling part
16 steering actuator
17 brake actuator
18 steering shaft
21 departure determining part
22 target trace line generating part
23 target lateral acceleration calculating part
24 target steering torque calculating part
25 target brake pressure calculating part
100 lane departure prevention support apparatus

### BEST MODE FOR CARRYING OUT THE INVENTION

In the following, embodiments will be described by referring to the accompanying drawings.

### First Embodiment

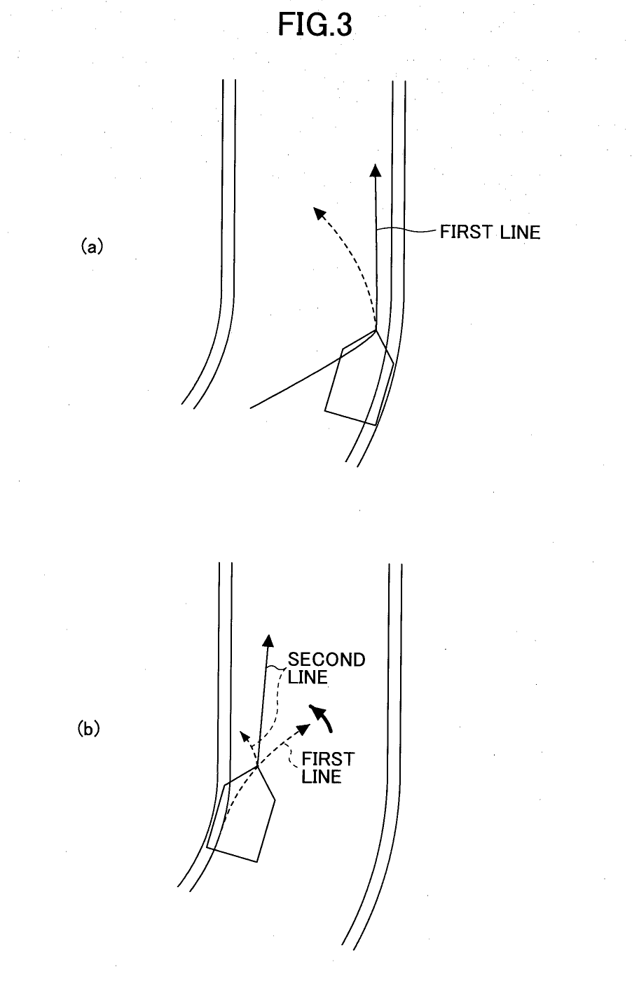

FIG. 3 is an example of a diagram for explaining departure prevention at the exit of the curve by a lane departure prevention support apparatus according to an embodiment. In the present embodiment, the target trace line including two lines, i.e., a first line and a second line is set when a departure tendency is detected.

The first line corresponds to a target trace line for reducing the departure at the exit of the curve. The second line corresponds to a target trace line for modifying a direction of the vehicle after the reduction of the departure.

FIG. 3 (a) is an example of a diagram for explaining the departure reduction when the departure occurs in the outward direction of the curve at the exit of the curve. At the time of the departure in the outward direction of the curve, the lane departure prevention support apparatus according to the embodiment set the first line such that it is substantially straight. The first line which is straight has a different direction with respect to a traveling line based on the curvature that is detected when the departure tendency is detected. Thus, at the time of the outward departure, it is possible to reduce a possibility that the vehicle departs from the lane at the exit of the curve in comparison with the first line (dotted line) according to prior art.

FIG. 3 (b) is an example of a diagram for explaining the departure reduction when the departure occurs in the inward direction of the curve at the exit of the curve. At the time of the departure in the inward direction of the curve, the lane departure prevention support apparatus sets the second line such that it is substantially straight after the departure reduction with the first line. Although the first line is substantially the same as the target trace line used in the departure reduction according to prior art, the second line that is made straight after the departure reduction has a different direction with respect to a traveling line based on the curvature that is detected when the departure tendency is detected. Thus, at the time of the inward departure, it is possible to reduce a possibility that the vehicle departs from the lane at the exit of the curve in comparison with the second line (dotted line) according to prior art.

In this way, with respect to the target trace line for which the first and second lines can be set, the first line in the case of the outward departure detected at the exit of the curve and the second line in the case of the inward departure detected at the exit of the curve are both made substantially straight, which enables reducing the departure at the exit of the curve. Further, because the substantially straight lines are used as a target trace line, the vehicle stability can be increased.

It is noted that the curve represents a road shape that is curved in an arc or curved line; however, the curvature is not necessarily constant. The curved line may be connected to the straight line and the curved line may partially include the straight line.

### Configuration Example

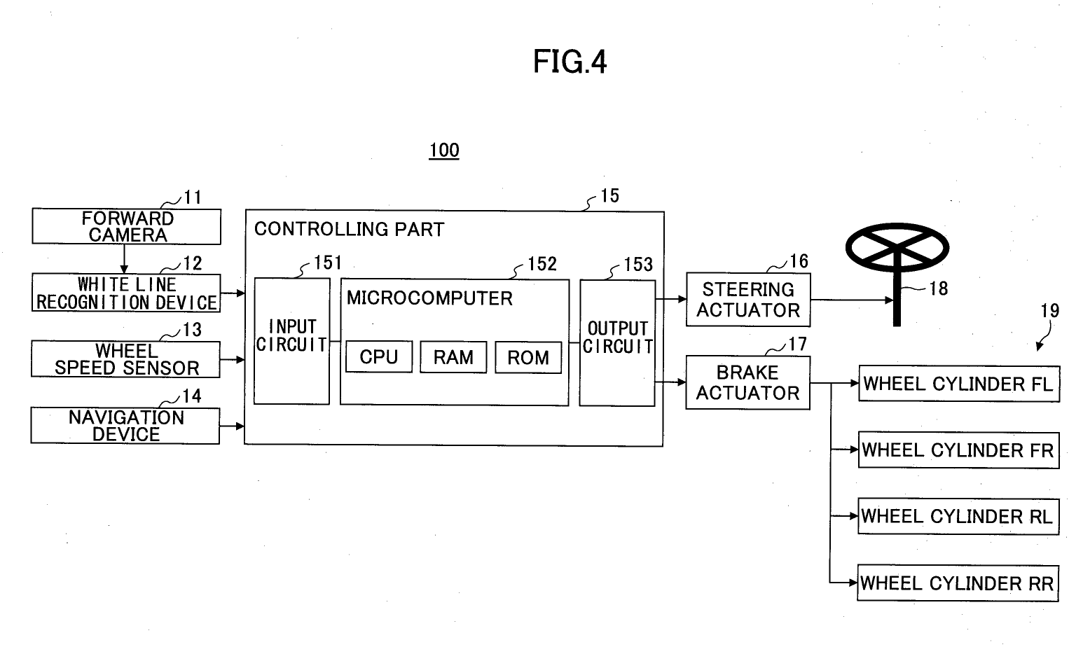

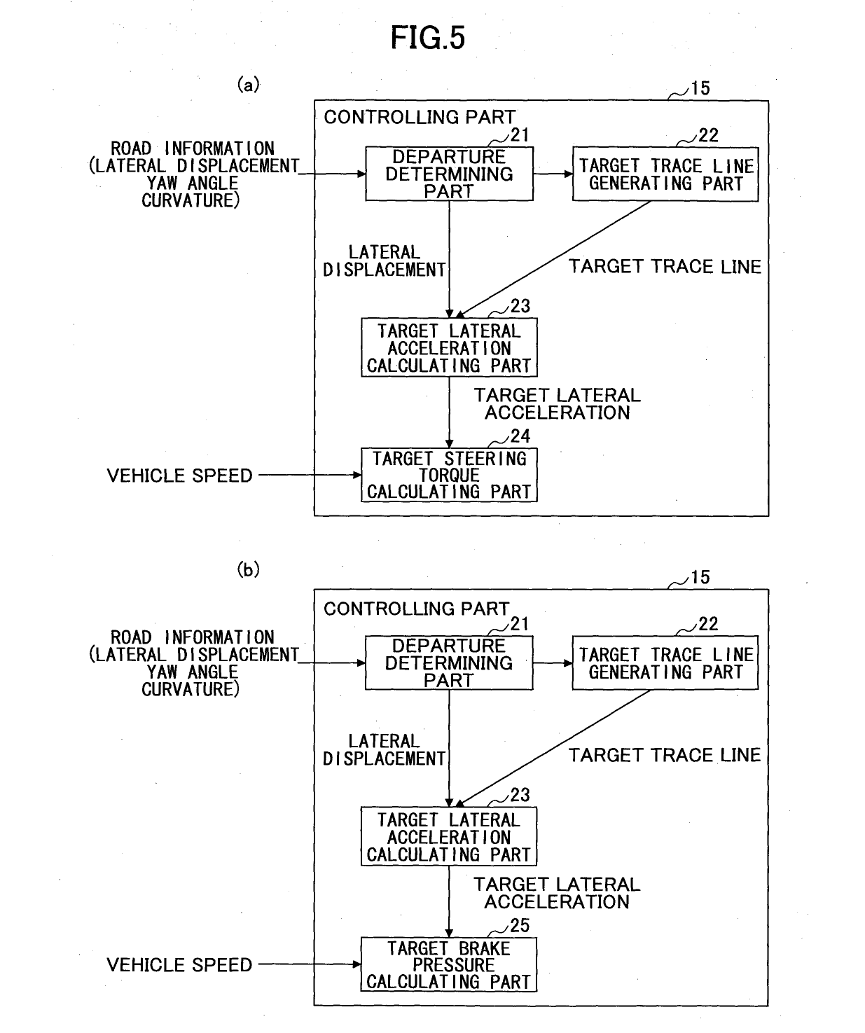

FIG. 4 is an example of a diagram for illustrating a schematic configuration of a lane departure prevention support apparatus. The lane departure prevention support apparatus 100 is controlled by a controlling part 15. The lane departure prevention support apparatus 100 includes a forward camera 11, a white line recognition device 12, a wheel speed sensor 13, a navigation device 14, a steering actuator 16 and a brake actuator 17.

The forward camera 11 is a single camera or a stereo camera that captures a scene around the host vehicle that mainly includes a predetermined region in front of the host vehicle. Photoelectric conversion elements of the camera are CCDs, CMOSs, etc. The forward camera 11 outputs image data, which is obtained by capturing the scene in front of the host vehicle, to the white line recognition device 12. The operation for capturing the scene in front of the host vehicle is performed periodically at a predetermined frame rate (30 through 60 frames per sec, for example).

The white line recognition device 12 recognizes a lane boundary sign from the image data to calculate road information. The lane boundary sign represents a road surface sign for delimiting the traveling lane. For example, the lane boundary sign is a line-shaped sign formed by applying paint which can be recognized from a road surface, such as white paint, in line shape along the road. Further, there is a white line formed in a chromatic color such as yellow or orange, depending on the road rules or the nation. Further, the lane boundary sign includes, in addition to a line-shaped sign, a dotted line or a broken line which has portions in which paint is not applied at a predetermined interval. Further, when the traveling lane is delimited by a three-dimensional object such bots dots in the United State of America, in stead of the paint, such a three-dimensional object is also included in the lane boundary sign. Further, when the traveling lane is delimited by arranging light emitting objects such as lamps or cat's eye along the road, these objects are also included in the lane boundary sign.

Further, the road information includes an angle (yaw angle) φ between a direction of the traveling lane of the host vehicle and a forward and backward direction of the host vehicle (an axis line C described hereinafter); a lateral displacement X from the center of the traveling lane to the center of the vehicle; and a curvature β of the traveling lane. The white line recognition device 12 outputs the road information, which is calculated from the image data, to the controlling part 13.

The wheel speed sensor 13 detects respective wheel speeds of a left front wheel FL, a right front wheel FR, a left rear wheel RL and a right rear wheel RR. The controlling part 15 adopts an average of two wheel speeds of the driven wheels, among the respective wheel speeds of the wheels, as a vehicle speed of the vehicle.

The navigation device 14 detects a position of the host vehicle, using a GNSS (global navigation satellite system), for example, to identify a traveling position on a road map. For example, with the navigation device 14, such situations where the vehicle approaches the curve, the vehicle is traveling on the curve, the vehicle is near the exit of the curve, etc., can be detected.

The steering actuator 16 is an electric motor that rotationally drives a steering shaft 18. A steering torque sensor is provided on the steering shaft 18 to perform a steering assist by adding an assist torque in a driver's steering direction. Further, the steering actuator 16 rotationally drives the steering shaft 18 with a steering torque that is instructed according to the target trace line. With this arrangement, the vehicle can be steered with the steering torque for the departure reduction.

The brake actuator 17 is connected to wheel cylinders 19 (referred to as wheel cylinders FL through RR, hereinafter) for braking the respective wheels independently. In order to independently control a braking pressure on a wheel basis, the brake actuator 17 adjusts the degree of opening of solenoid valves disposed in fluid channels for brake fluid to control wheel cylinder pressures of the wheel cylinders FL through RR. With this arrangement, it is possible to apply an arbitrary yaw moment to the vehicle body. Applying an appropriate yaw moment to the vehicle body can reduce the departure.

The controlling part 15 is configured by one or more electronic control units, and mainly includes a microcomputer 152, an input circuit 151 and an output circuit 153. A CPU of the microcomputer 152 executes a program to determine a target steering torque based on the road information to control the steering actuator 16. Further, the CPU determines a brake oil pressure based on the road information to control the brake actuator 17.

[Example of Functions of Controlling Part]

FIG. 5 (a) is an example of a function block diagram of the controlling part 15. The road information and the vehicle speed are input to the controlling part 15 that outputs the target steering torque to the steering actuator 16.

The controlling part 15 includes a departure determining part 21, a target trace line generating part 22, a target lateral acceleration calculating part 23 and a target steering torque calculating part 24. Functions of the respective parts are described hereinafter. The departure determining part 21 determines whether the vehicle departs from the traveling lane. The target trace line generating part 22, if it is determined that the vehicle departs from the traveling lane, generates the target trace line (the first and second lines) for reducing the departure. The target lateral acceleration calculating part 23, if it is determined that the vehicle departs from the traveling lane, calculates a target lateral acceleration, which is a lateral acceleration of the vehicle, such that the vehicle travels along the target trace line. The target steering torque calculating part 24 calculates a target steering torque based on the target lateral acceleration.

Further, as illustrated in FIG. 5 (b), the control for the departure reduction is performed with yaw moment which is generated by braking the outer wheels or the inner wheels. Such a control does not require an electric power steering system and thus leads to a cost reduction. Further, if the electric power steering system is installed, the steering actuator 16 need not generate a great torque, which can reduce a vehicle weight and the amount of heat. A target brake pressure calculating part 25 in FIG. 5 (b) calculates a target brake pressure based on the target lateral acceleration.

It is noted that the controlling part 15 may include both the target steering torque calculating part 24 and the target brake pressure calculating part 25. With this arrangement, the control can be performed by dividing the control amount for the departure reduction into the steering torque and the yaw moment.

[Example of Calculation of Road Information]

The lane departure prevention support apparatus 100 mainly includes two types, that is to say, a LKA (Lane Keeping Assist) that supports a driver's steering operation such that the vehicle travels to keep the traveling lane, and a LDW (Lane Departure Warning) that is operated when the departure from the traveling lane is detected. According to the LKA, the steering torque and the braking force are always assisted according to the lateral displacement with respect to the target traveling line (traveling lane center), the yaw angle, etc., and, when the departure tendency is detected, the departure reduction with the steering torque or the yaw moment is performed. According to the LDW, when the departure tendency is detected, the departure reduction with the steering torque or the yaw moment is performed.

Because the LKA and the LDW are the same in terms of performing the departure reduction when the departure tendency is detected, the departure reduction according to the embodiment can be applied effectively. In the following, the case of the LDW is explained as an example.

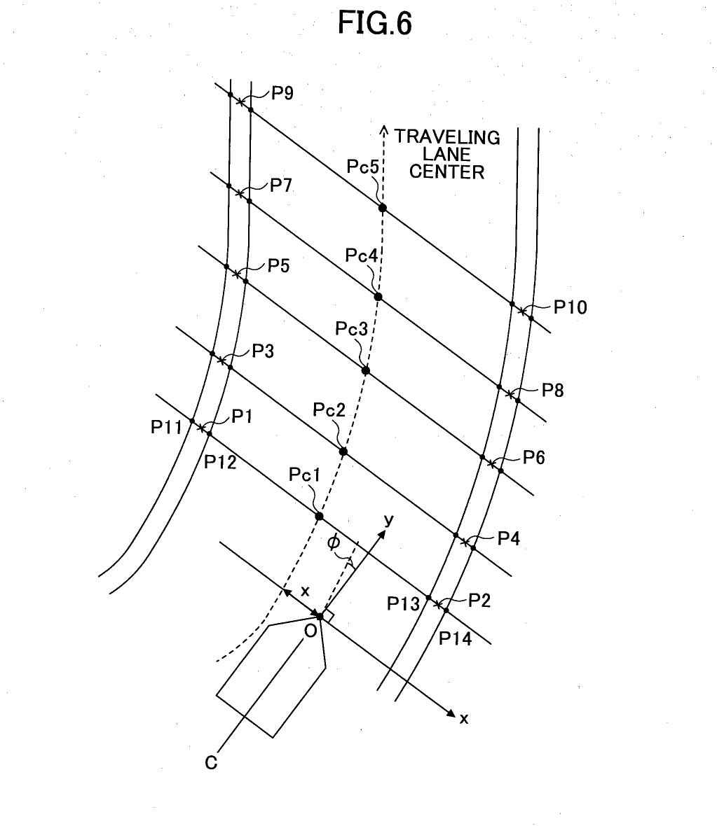

FIG. 6 is an example of a diagram for explaining a calculation of the road information by the white line recognition apparatus 12. The white line recognition device 12 scans luminance information in a horizontal direction on a predetermined interval basis of the imaged data in the vertical direction. In this way, horizontal edges with strength greater than a predetermined value are detected. The predetermined interval corresponds to an interval of 5 m to 10 m in a real space. At pixels where the lane boundary sign exists, edges (a raising edge and a falling edge in the case of scanning from the left side) at the opposite ends in a left and right direction are detected on a lane boundary sign basis.

As illustrated in FIG. 6, P11, P12 and P13, P14 are detected in the case of the forefront scanning line. A center P1 of the pair of the edges (P11 and P12) represents the position of the lane boundary sign on the left side, and a center P2 of the pair of the edges (P13 and P14) represents the position of the lane boundary sign on the right side.

Because a focal length of the forward camera 11, etc., is known, the positions P1 through P10 of the lane boundary signs in the real space can be calculated. For example, the mounting position of the forward camera 11 is set as an original point O, a y-axis is set in parallel to an axis line C of the forward and backward direction of the host vehicle, an x-direction is set such that it is perpendicular to the axis line C.

Next, curve fitting is applied to the positions P1, P3 and P5 of the lane boundary sign on the left side and the positions P2, P4 and P6 of the lane boundary sign on the right side, respectively, to determine curvatures of the respective lane boundary signs. When it is assumed that the lane boundary sign is a part of a circle, the positions P1, P3, P5, P7 and P9 are on the circle. Thus, the curve fitting to the circle is performed with a least squares method using X coordinates (Xc) and Y coordinates (Yc). Function f used for the least squares method may be a function representing a circle as follow, for example. a is the X-coordinate of the center of the circle, and b is Y-coordinate of the center.

f={(Xc−a)²+(Yc−b)²}^{1/2}

A distance from the center of the circle to the lane boundary sign corresponds to a radius of the circle, and thus an inverse number of the distance is a curvature β. The curvature can be determined similarly with respect to the positions P2, P4, P6, P8 and P10.

The function used for the least squares method is not necessarily a function of the circle, and thus a function of a curved line may be used as well. Further, instead of using the least squares method, a Hough transformation is used to calculate parameters (a center, a radius, a curvature) of the circle.

The traveling lane center of the traveling lane may be determined as midpoints Pc1 through Pc5 of the positions P1 through P10, or may be determined based on two concentric circles obtained by the curve fitting. Further, the traveling lane center is not necessarily a complete midpoint and thus the traveling line may be biased in a left or right direction with respect to the midpoint. According to the LKA, the traveling lane center becomes the target traveling line when the vehicle travels.

A distance between the traveling lane center and the host vehicle position (the original point O) in the x-axis direction corresponds to a lateral displacement X. Further, an angle between the axis line C and the target traveling line corresponds to a yaw angle φ. The white line recognition device 12 outputs the lateral displacement X, the yaw angle φ and the curvature β thus obtained to the controlling part 15 as road information.

It is noted that in the road information the left direction is positive. Specifically, with respect to the lateral displacement X, it is positive if the vehicle is biased in the left direction from the traveling lane center. With respect to the yaw angle φ, it is positive if the axis line C is directed in the left direction from the target trace line. With respect to the curvature β, it is positive in the case of the left curve.

The curvature has a relatively great variation due to the limited recognition accuracy of the lane boundary sign and the curve fitting, etc. For this reason, the white line recognition device calculates the curvature after performing the low-pass filtering. The low-pass filter includes a filter for calculating an average of the past several values, a filter in which the higher weight is applied to the newer curvature, etc., for example.

The shape of the lane boundary sign determined by the curve fitting substantially corresponds to the actual shape of the lane boundary sign; however, at the exit of the curve, because the curve is connected to the straight line via a clothoid curve, the curvature changes gradually. For this reason, due to the effect of the low-pass filter, the curvature that is greater (in an absolute value) than the actual curvature of the road on which the vehicle is going to travel is calculated at the exit of the curve.

[Departure Determination]

The departure determining part 21 determines whether the vehicle departs from the traveling lane. For the departure determination, a departure prediction time is used which is a time until the lateral displacement X of the vehicle corresponds to the lane boundary sign on the left or right side. The white line recognition device 12 calculates the lateral displacement X periodically, and thus a movement speed Vx in the x-axis direction is known. When a road width is D, the departure prediction time can be determined with the following formula.

It is noted that the departure prediction time is calculated with respect to the closer lane boundary sign when the lateral displacement X of the vehicle is closer to one of the lane boundary′ signs on the opposite sides.

If the vehicle approaches the lane boundary sign on the right side (X, Vx<0), the departure prediction time is calculated as follows.

Departure prediction time=(D/2−|X|)/|Vx|

If the vehicle approaches the lane boundary sign on the left side (X, Vx>0), the departure prediction time is calculated as follows.

Departure prediction time=(D/2−X)/Vx

The departure determining part 21 detects the departure tendency if the departure prediction time becomes less than or equal to a threshold. In this way, the target trace line for the departure reduction described hereinafter is generated. The threshold for detecting the departure tendency is 0.5 through 2 [sec], for example; however, the threshold may be determined dynamically according to the vehicle speed. When a time delay before the vehicle or the driver thereof performs the action for preventing the departure, the detection of the departure tendency can be regarded as the detection of the departure, though it depends on the threshold.

Further, when a predetermined part of the vehicle is located above the lane boundary sign, the departure tendency may be detected. The predetermined part of the vehicle may be the center (original point O), the left end of the vehicle body (in the case of the departure from the lane boundary sign on the left side), the right end of the vehicle body (in the case of the departure from the lane boundary sign on the right side), the left wheel (in the case of the departure from the lane boundary sign on the left side), the right wheel (in the case of the departure from the lane boundary sign on the right side), etc.

[Determination of Departure Direction]

The target trace line to be generated differs between the case of the outward departure at the exit of the curve and the case of inward departure at the exit of the curve. For this reason, the departure determining part 21 determines whether the outward departure or the inward departure. The target trace line generating part 22 may determine the departure direction.

When the departure direction of the vehicle and the direction of the curve (i.e., the curved direction of the road) are opposite, it is determined that the vehicle departs to outward side of the curve. When the departure direction of the vehicle and the direction of the curve are the same, it is determined that the vehicle departs to inward side of the curve. The departure direction is determined based on a sign of the lateral displacement X. The departure direction is a left direction if the lateral displacement X is positive and a right direction if the lateral displacement X is negative. Further, the direction of the curve can be determined by various ways. The direction of the curve can be determined based on the current rotation direction of the steering shaft 18, the direction of the lateral acceleration G, the center coordinate of the circle for which the curvature β is calculated, the information from the navigation device or road-vehicle communications, etc.

[Target Trace Line]

The target trace line generating part 22 generates the target trace line, if the departure determining part 21 determines that the vehicle departs from the lane. The target trace line includes the first line for the departure reduction and the second line for modifying the direction of the vehicle after the departure reduction. There may be a third line and so on; however, the explanation thereof is omitted.

First, the first line and the second line, which form a base of the embodiment (it never means that they are prior art), are explained.

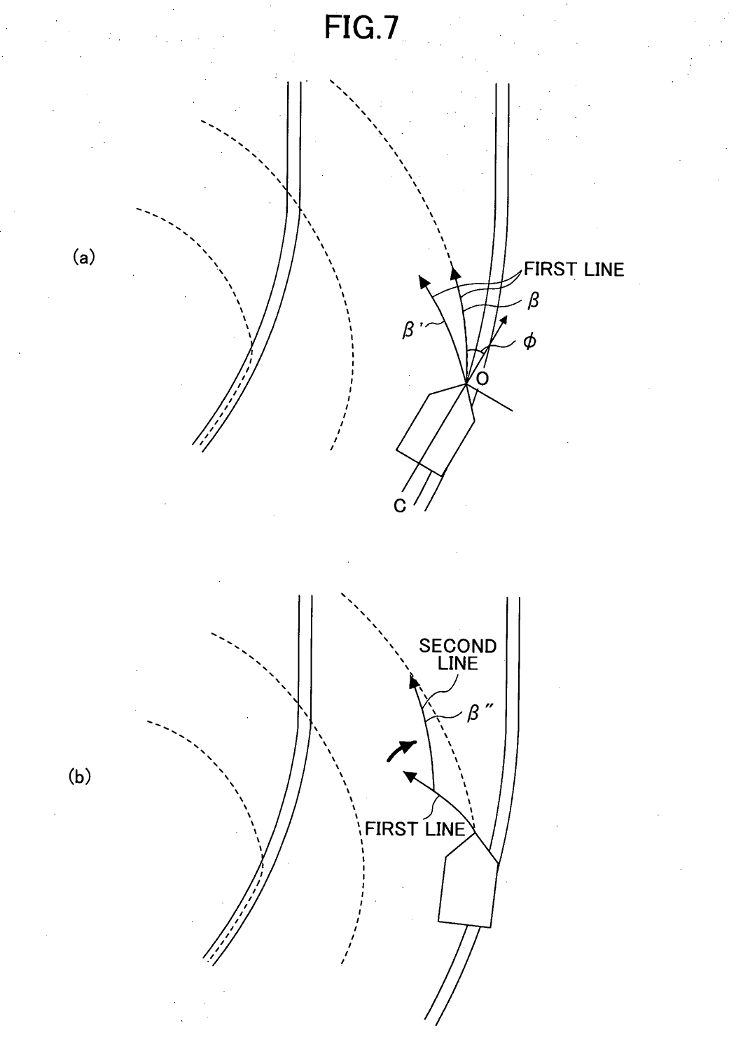

FIG. 7 (a) is an example of a diagram for explaining the first line in the case of the outward departure. In the case where the departure tendency in the outward direction is detected, the target trace line for reducing the departure is located inwardly with respect to the outward lane boundary sign (dotted line) for which the curvature β is recognized. Specifically, the target trace line has at least substantially the same direction as the outward lane boundary sign, and preferably the target trace line is somewhat inward with respect to the outward lane boundary sign (dotted line). The shape of the outward lane boundary sign is determined based on the curvature that is detected by the white line recognition device 12 based on the positions P2, P4, P6, P8 and P10 of the edge.

In order that the target trace line is somewhat inward with respect to the outward lane boundary sign (dotted line), the first line is set such that its curvature is greater than the curvature β of the lane boundary sign (i.e., a radius of the first line is less than that of the lane boundary sign). The curvature β′ of the first line is calculated as follows, for example. Δβ is an increased amount of the curvature and may be 10 through 30 percent of the curvature, for example.

β′=β+Δβ

A curved line of the curvature β′ (positive because of the left cornering) that passes through the original point O of the vehicle for which the departure tendency is detected becomes the first line of the target trace line. The lateral displacement X is a displacement amount of the original point O with respect to the target trace line, and the yaw angle φ is an angle between the target trace line and the axis line C. If the vehicle travels along the target trace line, the departure can be reduced.

FIG. 7 (b) is an example of a diagram for explaining the second line in the case of the outward departure. Because the vehicle after the departure has been reduced by the first line is directed inwardly with respect to the outward lane boundary sign, there is a possibility that the vehicle departs from the inward lane boundary sign if the direction of the vehicle is not modified (i.e., the direction of the vehicle needs to be modified). Thus, the second line is set for modifying the direction of the vehicle, which has been formed by using the first line as the target trace line, such that the direction of the vehicle changes outwardly.

The second line has the direction modified outwardly with respect to the first line (the curvature is reduced) and is located inwardly with respect to the outward lane boundary sign.

Curvature of the second line β″=β′−(Δβ/n)

n is a real number greater than 1. In other words, the target trace line is modified in such a direction that its curvature becomes closer to the curvature β′ by a range less than Δβ.

In this way, by determining the first line and the second line, the yaw angle is changed greatly in the inward direction for reducing the departure immediately after the departure tendency is detected, and the direction of the vehicle can be modified such that it becomes closer to the curvature of the lane boundary sign after the departure reduction.

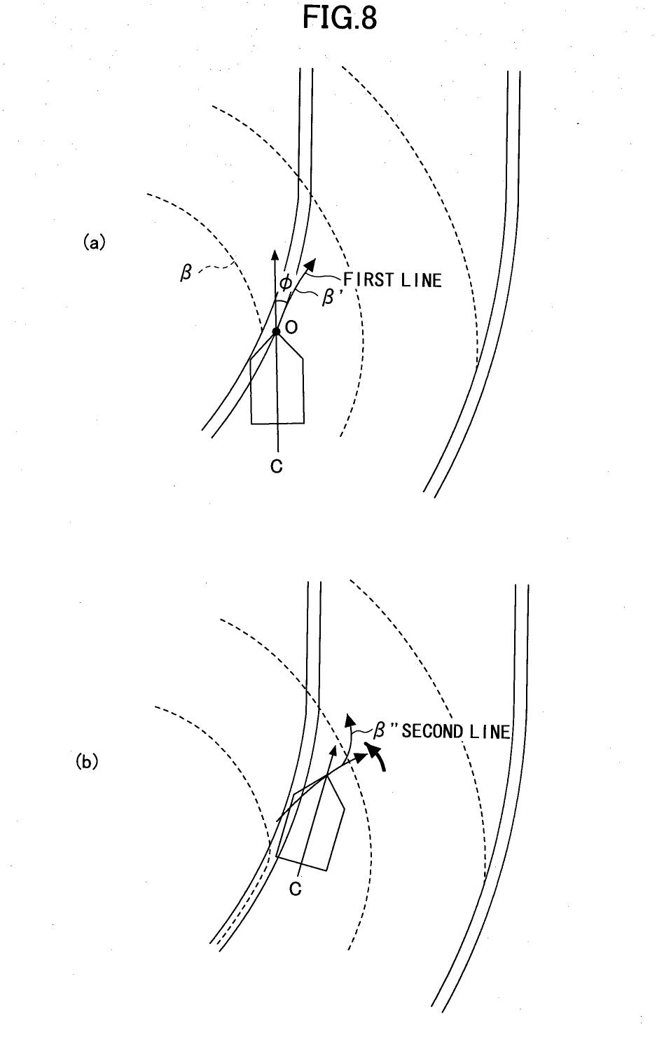

FIG. 8 (a) is an example of a diagram for explaining the first line in the case of the inward departure. In the case where the departure tendency in the inward direction is detected, the target trace line for reducing the departure is located outwardly with respect to the inward lane boundary sign (dotted line) for which the curvature β is recognized. Specifically, as a simple method, reversing the sign of the curvature (changing the left cornering to the right cornering in the illustrated example) enables the target trace line to be located outwardly with respect to the shape of the inward lane boundary sign (dotted line). The greater an absolute value of the curvature β becomes, the more greatly the target trace line is changed. Further, a curved line for changing the direction of the vehicle outwardly by the yaw angle φ with respect to the lane boundary sign (dotted line) may be used as the first line.

However, because a rapid change in the steering direction makes the vehicle unstable, the first line is set such that the yaw angle φ of the first line with respect to the axis line C does not exceed a threshold.

Curvature of first line β′=−1×β (where φ is less than or equal to the threshold)

A curved line of the curvature β′ (negative because of the right cornering) that passes through the original point O of the vehicle for which the departure tendency is detected becomes the first line of the target trace line. The lateral displacement X is a displacement amount of the original point O with respect to the target trace line, and the yaw angle φ is an angle between the target trace line and the axis line C. If the vehicle travels along the target trace line, the departure can be reduced.

FIG. 8 (b) is an example of a diagram for explaining the second line in the case of the inward departure. Because the vehicle after the departure has been reduced by the first line is directed outwardly with respect to the inward lane boundary sign (dotted line), there is a possibility that the vehicle departs from the outward lane boundary sign if the direction of the vehicle is not modified (i.e., the direction of the vehicle needs to be modified). Thus, the second line is set for modifying the direction of the vehicle, which has been formed by using the first line as the target trace line, such that the direction of the vehicle changes inwardly.

The second line has the direction modified inwardly with respect to the first line. Specifically, decreasing the curvature β′ (absolute value) by a small amount can make the curvature gentle. Δβ is as described above.

Curvature of second line β″=β′ (negative value)+Δβ (positive value)

It is noted that the described way of setting the first and second lines is just one example. The first line may be any line that can achieve the purpose of reducing the departure, and the second line may be any line that can achieve the purpose of modifying the direction of the vehicle.

Next, the target trace line according to the embodiment is described.

In the case of the outward departure, even if the first and second lines are generated as described above, there is still a problem remaining that the vehicle may depart from the lane inwardly because of the influence from the curvature of the lane boundary sign (dotted line) calculated when the departure tendency is detected. Further, in the case of the inward departure, there is still a problem remaining that the vehicle may depart from the inward lane boundary sign due to the influence from the curvature of the lane boundary sign (dotted line) calculated when the departure tendency is detected, because the second line modified from the first line tends to be directed inward.

Therefore, according to the embodiment, these problems are reduced by making the first line or the second line substantially straight at the exit of the curve.

In the case of the outward departure:

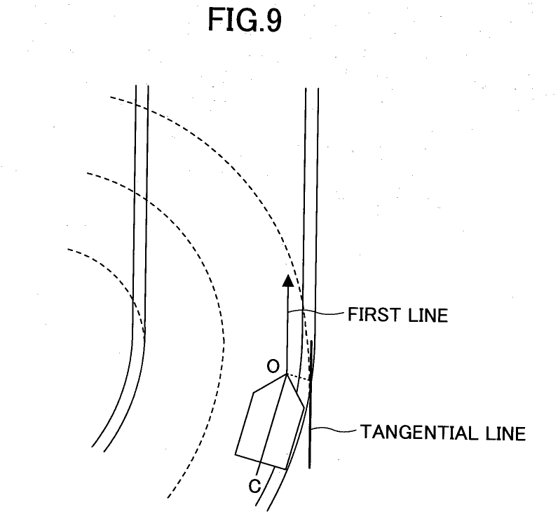

FIG. 9 is an example of a diagram for explaining a target trace line in the case of the outward departure.

When the outward departure is detected, the target trace line generating part 22 generates the target trace line such that the first line is substantially straight.

A starting point of the straight line is the original point O of the vehicle at the time when the departure tendency is detected. There are many ways of determining the direction of the straight line.

(i) A tangential direction of the lane boundary sign (dotted line) when the departure tendency is detected.
(ii) A direction that is obtained by modifying the tangential direction described in (i) inwardly.
(iii) A direction that is obtained by modifying the direction of the axis line C inwardly.

As illustrated in FIG. 7, because the direction of the first line (and the direction of the second line) generated at the exit of the curve is similar to the direction of the lane boundary sign (dotted line) that is calculated when the departure tendency is detected, there is a problem that the vehicle may depart from the lane in the inward direction of the curve again; however, the departure can be reduced by setting the first line such that it is substantially straight.

In the case of the inward departure:

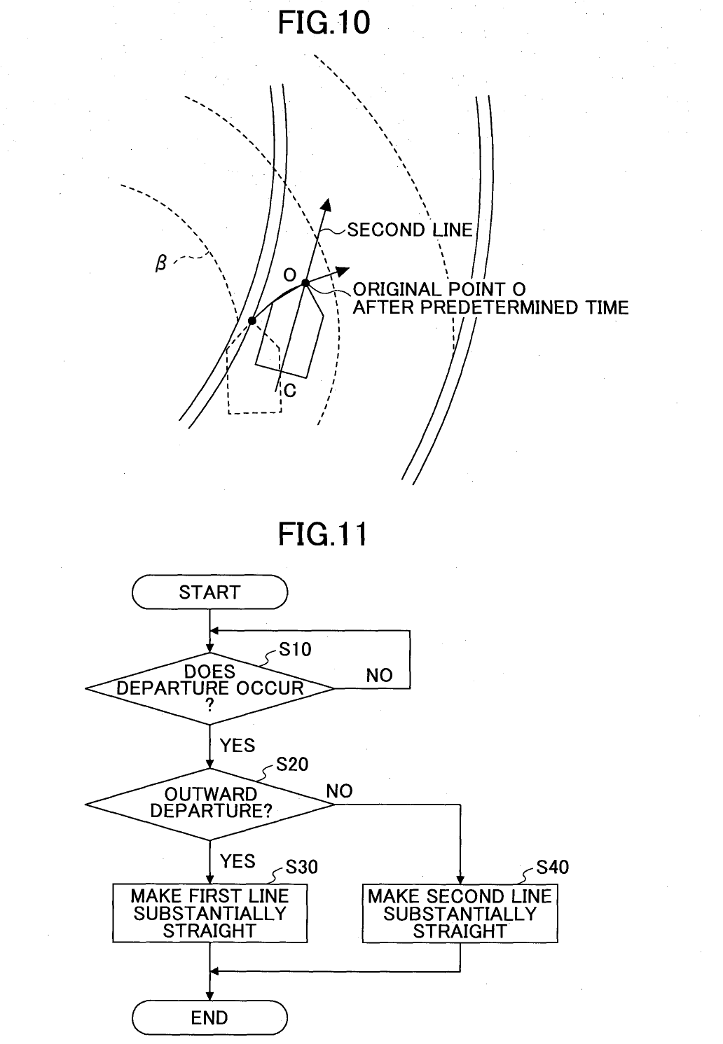

FIG. 10 is an example of a diagram for explaining a target trace line in the case of the inward departure.

When the inward departure is detected, the target trace line generating part 22 makes the second line substantially straight.

A starting point of the straight line is the original point O of the vehicle after the vehicle has traveled along the first line for a predetermined time, for example. There are many ways of determining the direction of the straight line.

(i) A direction of the axis line C of the vehicle after the vehicle has traveled along the first line for a predetermined time.
(ii) A direction that is obtained by modifying the direction described in (i) in the left or right direction by a predetermined angle.

As illustrated in FIG. 8, because the direction of the second line generated at the exit of the curve may be directed inwardly depending on the direction of the first line or the modified amount of the second line, and the vehicle travels near the inward lane boundary sign, there is a problem that the vehicle may depart from the lane again; however, the departure can be reduced by setting the second line such that it is substantially straight.

It is noted that the term “substantially straight” corresponds to a straight line itself or a curved line in a strict sense which can be regarded as a straight line (its curvature is substantially 0, its radius is extremely great. Specifically, the vehicle travels in a straight line when the steering angle or the steered angle is in its nominal status.

The first line generated at the time of the outward departure or the second line generated at the time of the inward departure is kept until the departure is detected again or is canceled when the driver performs a steering operation with a steering torque greater than a predetermined torque.

[Calculation of Target Lateral Acceleration]

The target lateral acceleration calculating part 23 outputs the target lateral acceleration for traveling along the target trace line. The target lateral acceleration calculating part 23 calculates the target acceleration using the target trace line and the road information about the target trace line. The target lateral acceleration is calculated as follows, for example, where G1 is a feed-forward operator (gain), G2 is a feed-back operator and G3 is a feed-back operator.

Target lateral acceleration Gx=G1×V²×β+G2×φ+G3×X

It is noted that the described calculation method is just one example. The target lateral acceleration may be calculated from the lateral displacement X and the yaw angle φ only, or a speed is included in the feed-back term of the yaw angle φ. Further, as a simple example, the target lateral acceleration may be read from a map in which the target lateral acceleration Gx is associated with the lateral displacement X and the yaw angle φ.

It is noted that, in the case of LKA, the target lateral acceleration calculating part 23 outputs the target lateral acceleration for traveling along the traveling line at the traveling lane center; however, the explanation thereof is omitted.

[Calculation of Target Steering Torque]

The target steering torque calculating part 24 calculates the target steering torque based on the target lateral acceleration and the vehicle speed.

Specifically, the target steering torque calculating part 24 determines a gain K according to the vehicle speed, and calculates the target steering torque based on the target lateral acceleration and the gain K with the following formula.

Target steering torque ST=K×Gx

The gain, K is a function of the vehicle speed considering the fact that the steering torque needed to trace the target trace line varies according to the vehicle speed. With this arrangement, it becomes possible to prevent unstable behavior of the vehicle at the high speed range while ensuring the steering operations with reliability at the low speed range.

The target steering torque calculating part 24 outputs the target steering torque to the steering actuator 16. In this way, the vehicle can travel such that it traces the target trace line.

[Calculation of Target Brake Torque]

The case where the departure is reduced by the yaw moment with the configuration in FIG. 5 (b) is explained. The target brake pressure calculating part 25 calculates a target brake torque based on the target lateral acceleration and the vehicle speed. Specifically, target brake pressure calculating part 25 calculates a target cylinder pressure difference ΔPf of the front wheel and a target cylinder pressure difference ΔPr of the rear wheel based on the target lateral acceleration.

ΔPf=2×Cf×(target lateral acceleration−Th)/Tr

ΔPr=2×Cr×target lateral acceleration/Tr

Tr is a tread length, and Cf and Cr are conversion factors when the lateral acceleration is converted to the wheel cylinder pressure. Further, Th is a coefficient for making the target cylinder pressure difference ΔPf of the front wheel smaller than the target cylinder pressure difference ΔPr of the rear wheel.

In the case of the outward departure, the target wheel cylinder pressure of the outward front wheel (front left wheel in the case of the left curve) is made greater than the target wheel cylinder pressure of the inward front wheel by the target cylinder pressure difference ΔPf, and the target wheel cylinder pressure of the outward rear wheel is made greater than the target wheel cylinder pressure of the inward rear wheel by the target cylinder pressure difference ΔPr. With this arrangement, the yaw moment is generated in the inward direction and the departure can be reduced.

Further, in the case of the inward departure, the target wheel cylinder pressure of the outward front wheel (front right wheel in the case of the left curve) is made greater than the target wheel cylinder pressure of the inward front wheel by the target cylinder pressure difference ΔPf, and the target wheel cylinder pressure of the outward rear wheel is made greater than the target wheel cylinder pressure of the inward rear wheel by the target cylinder pressure difference ΔPr. With this arrangement, the yaw moment is generated in the outward direction and the departure can be reduced.

[Operation Procedure]

FIG. 11 is an example of a flowchart for illustrating an operation procedure of the lane departure prevention support apparatus 100.

The departure determining part 21 periodically determines, based on the departure prediction time, etc., whether the vehicle departs from the lane (S10). If the departure tendency is not detected, the departure determination is performed repeatedly.

If the departure tendency is detected (Yes in S10), the departure determining part 21 determines whether the departure is in the outward direction of the curve (S20). It is noted that when the departure tendency is detected, it may be determined whether the vehicle is traveling on the curve, and when the vehicle is traveling on the curve, it may be further determined whether the vehicle is traveling at the exit of the curve.

In the case of the outward departure (Yes in S20), the target trace line generating part 22 generates the target trace line such that the first line is substantially straight (S30).

In the case it is not outward departure (No in S20), therefore meaning the inward departure, the target trace line generating part 22 generates the target trace line such that the second line is substantially straight (S40).

As described above, because the first line in the case of the outward departure detected at the exit of the curve and the second line in the case of the inward departure detected at the exit of the curve are made substantially straight, the departure at the exit of the curve can be reduced.

### Second Embodiment

In the first embodiment, the second line is described such that it modifies the direction of the vehicle after the departure reduction. According to the embodiment, a lane departure prevention support apparatus is described in which, instead of determining the second line, by fixing the target steering torque of the second line, the direction of the vehicle formed by the first line is modified and the behavior of the vehicle is stabilized.

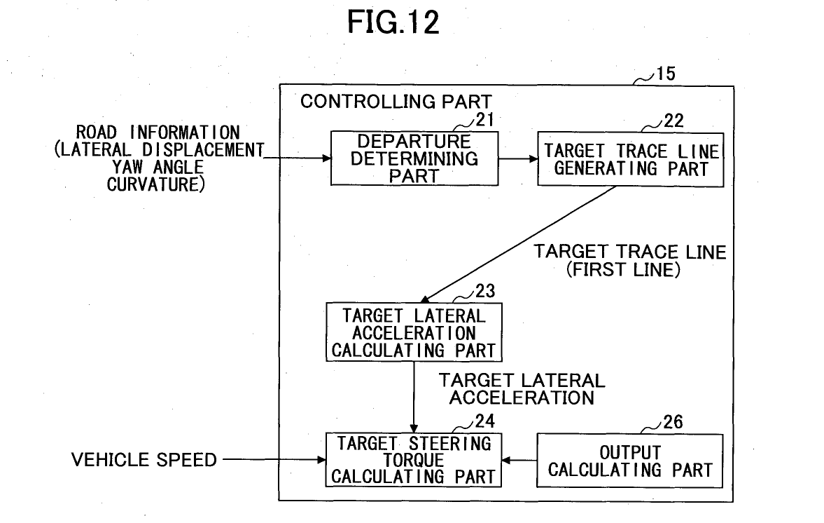

FIG. 12 is an example of a function block diagram of the controlling part 15. In the embodiment, the components given the same reference numbers have the same functions, and thus only the main components of the embodiment are mainly described.

The target trace line generating part 22 in FIG. 12 generates only the first line. Further, the controlling part 15 in FIG. 12 includes an output calculating part 26. The output calculating part 26 determines the target steering torque of the second line according to the target steering torque of the first line. In other words, the target steering torque of the second line is automatically determined by the target steering torque of the first line (fixed by the target steering torque of the first line).

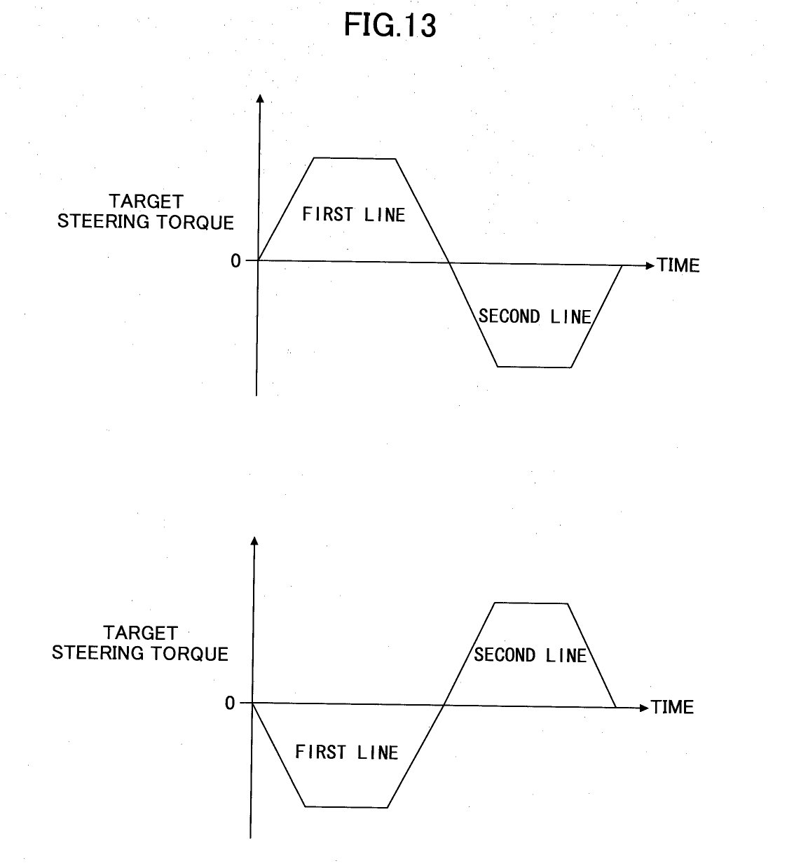

FIG. 13 (a) is an example of a diagram for illustrating the first line at the outward departure and the target steering torque of the second line, and FIG. 13 (b) is an example of a diagram for illustrating the first line at the inward departure and the target steering torque of the second line. The left curve is assumed in both cases.

As illustrated in FIG. 7, because the first line is set inwardly with, respect to the outward lane boundary sign (dotted line), the positive target steering torque is output. The target steering torque of the second line is smaller than the target steering torque of the first line and has an opposite direction with respect to the target steering torque of the first line. For example, the target steering torque of the second line is determined as follows.

Target steering torque of second line=−P×target steering torque of first line

P is smaller than 1, and may be predetermined as 0.1 through 0.9, for example. Thus, the target steering torque of second line can be determined such that it has an opposite direction and a magnitude of 30 to 90 percent with respect to the target steering torque of the first line, and thus the direction of the vehicle after the departure reduction can be modified.

The magnitude of P is not necessarily a fixed value, and thus may be determined according to the magnitude of the target steering torque of the first line and the vehicle speed. For example, by making P such that the greater the target steering torque of the first line, the greater P becomes, the first line can be modified such that the greater the target steering torque of the first line, the greater the first line is modified.

Similarly, in the case of reducing the departure by the yaw moment instead of the steering torque, ΔPf and ΔPr of the second line are calculated based on the target brake torque of the first line.

Because the second line is fixed by the control output of the first line, the behavior of the vehicle can be stabilized more easily with respect to the case where the vehicle travels such that it traces the second line.

According to the embodiment, by fixing the target steering torque of the second line after the departure has been reduced by the first line, it becomes possible to modify the direction of the vehicle formed by the first line without determining the second line, and stabilize the behavior of the vehicle.

### Third Embodiment

According to the second embodiment, the target steering torque of the second line is determined based on the target steering torque of the first line. In the present embodiment, a lane departure prevention support apparatus is explained in which a target steering torque for traveling in a straight line is determined as the target steering torque of the second line. The functional block diagram is the same as that in the second embodiment.

In the first embodiment, the first line at the time of the outward departure and the second line at the time of the inward departure are made substantially straight. However, it is also effective to make the second line at the time of the outward departure substantially straight. Therefore, according to the embodiment, the first line at the time of the outward departure is not made straight and instead of it the second line is made straight. With this arrangement, it becomes easy to modify the direction of the vehicle after the departure reduction by the first line and stabilize the behavior of the vehicle at the time of the outward departure. Further, because the second line is made substantially straight, it becomes impervious to the curvature detected when the departure tendency is detected, which can reduce further departure.

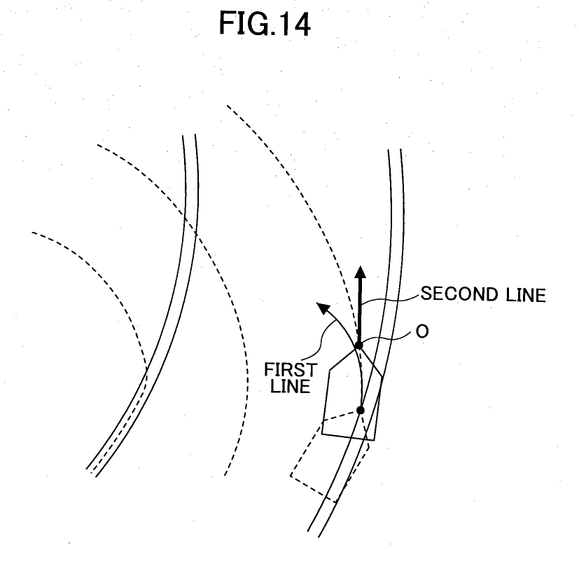

FIG. 14 is a diagram for schematically illustrating the second line that has made substantially straight at the time of the outward departure. The departure has been reduced by the first line, and thus the vehicle body is directed inwardly with respect to the outward lane boundary sign (dotted line). By making the second line straight in this status, it becomes possible to stabilize the behavior of the vehicle and reduce the possibility that the vehicle departs from the inward lane boundary sign again.

The direction of the straight line of the second line is determined by the target steering torque of the first line as described in the second embodiment. The target steering torque of the second line for the vehicle to travel in the substantially straight line along the second line is calculated as follows, for example.

(i) A map is prepared in advance in which the steering angle and the steering direction are associated with the target steering torque required to restore the steering direction to its nominal status. In this case, the output calculating part 26 reads the target steering torque associated with the steering angle at the time of switching to the second line. When the steering operation is performed with the target steering torque, the vehicle travels in the substantially straight line.
(ii) The positive steering torque or the negative steering torque with respect to the nominal status is summed and the summed torque is held. If the positive steering torque is summed at the time of switching to the second line, a negative torque for making the steering torque 0 is determined as the target steering torque of the second line. If the negative steering torque is summed at the time of switching to the second line, a positive torque for making the steering torque 0 is determined as the target steering torque of the second line.

According to the embodiment, by making the second line substantially straight at the time of the outward departure, it becomes easy to reduce the further departure and stabilize the behavior of the vehicle.

It is noted that in the first embodiment the target trace line of the second line at the time of the outward departure may be made substantially straight. In this case, the direction of the straight line corresponds to a direction that is obtained by modifying the direction of the axis line C after the vehicle has traveled along the first line for a predetermined time in the right direction, for example. Further, in the present embodiment, the target steering torque of the second line at the time of the inward departure may be determined based on the target steering torque of the first line such that it is substantially straight.

The present application is based on Japanese Priority Application No. 2013-128897, filed on Jun. 19, 2013, the entire contents of which are hereby incorporated by reference.

1. A departure prevention support apparatus, comprising:
a lane boundary sign recognizing part configured to analyze a captured image of a scene around a host vehicle to recognize a lane boundary sign;
a departure detecting part configured to detect a departure of the host vehicle from the lane boundary sign; and
a target travel line generating part configured to generate a target travel line if the departure detecting part detects the departure, wherein the target travel line includes a first target travel line for reducing the departure, and a second target travel line for modifying a direction of the host vehicle whose departure has been reduced after having traveled along the first target travel line; wherein
the target travel line generating part sets one of the first target travel line and the second target travel line such that it is substantially straight according to a direction of the departure detected by the departure detecting part and a direction of a curvature of the lane boundary sign.

2. The departure prevention support apparatus of claim 1, wherein the target travel line generating part sets the first target travel line such that it is substantially straight if the departure detecting part detects the departure in an outward direction of a curve.

3. The departure prevention support apparatus of claim 1, wherein the target travel line generating part sets the first target travel line such that it is substantially straight if the departure detecting part detects the departure in an inward direction of a curve.

4. The departure prevention support apparatus of claim 1, wherein the target travel line generating part sets the second target travel line such that it is substantially straight if the departure detecting part detects the departure in an outward direction of a curve.

5. The departure prevention support apparatus of claim 2, wherein the lane boundary sign recognizing part recognizes the lane boundary sign to calculate a curvature of the lane boundary sign, and
the target travel line generating part sets the substantially straight first target travel line such that it extends in a tangential direction of a circle with the calculated curvature if the departure detecting part detects the departure in an outward direction of a curve.

6. The departure prevention support apparatus of claim 3, wherein the target travel line generating part sets the substantially straight second target travel line such that it extends in a forward and backward direction of the vehicle after having traveled along the first target travel line if the departure detecting part detects the departure in an inward direction of a curve.

7. A departure prevention support apparatus, comprising:
a lane boundary sign recognizing part configured to analyze a captured image of a scene around a host vehicle to recognize a lane boundary sign;
a departure detecting part configured to detect a departure of the host vehicle from the lane boundary sign;
a target travel line generating part configured to generate a target travel line if the departure detecting part detects the departure, wherein the target travel line includes a first target travel line for reducing the departure, and a second target travel line for modifying a direction of the host vehicle whose departure has been reduced after having traveled along the first target travel line;
a control output calculating part configured to calculate a control output for traveling along the target travel line; and
a control output instructing part configured to determine the control output for traveling along the second target travel line according to the control output for traveling along the first target travel line.

8. The departure prevention support apparatus of claim 7, wherein the control output instructing part determines the control output such that the second target travel line becomes substantially straight if the departure detecting part detects the departure in an outward direction of a curve.

9. The departure prevention support apparatus of claim 1, further comprising a control output calculating part configured to calculate a control output for traveling along the target travel line, wherein
the control output calculating part calculates a target steering torque for traveling along the target travel line or calculates a target wheel braking pressure for generating a yaw moment for traveling along the target travel line.
